(19) United States
(12) Patent Application Publication
(10) Pub. No.: US 2022/0160472 A1
(43) Pub. Date: May 26, 2022

(54) A DENTAL IMPLANT ASSEMBLY

(71) Applicants: INDIAN INSTITUTE OF SCIENCE, Bangalore (IN); DEPARTMENT OF BIOTECHNOLOGY, New Delhi (IN); M S RAMAIAH UNIVERSITY OF APPLIED SCIENCES, Bangalore (IN)

(72) Inventors: Srimanta BARUI, Bangalore (IN); Vibha SHETTY, Bangalore (IN); Bikramjit BASU, Bangalore (IN)

(21) Appl. No.: 17/434,850

(22) PCT Filed: Feb. 28, 2020
(86) PCT No.: PCT/IB2020/051724

§ 371 Date: Aug. 30, 2021

(30) Foreign Application Priority Data
Feb. 28, 2019 (IN) 201841032295

(51) Int. Cl. A61C 8/00

(52) U.S. Cl. CPC A61C 8/0024; A61C 8/0025; A61C 8/0059; A61C 8/0069; A61C 8/0068

(57) ABSTRACT

A dental implant assembly comprises, a base member which is rotatably insertable into a jaw-bone. The base member may be defined by a collar portion, a mid-portion and an apical region. The base member in entirety may be configured with a tapered configuration right from the mid-portion to the apical region. Further, the base member is defined with a plurality of threaded profiles on an outer surface. A first thread profile is defined on the collar portion. A second thread profile, defined on the mid-portion and a third thread profile, defined on the apical region. The third thread profile is configured to cut into the jaw-bone during insertion to anchor the base member. As the third thread profile cuts in to the jaw bone, the second thread profile forms a threaded hole within the drilled hole in order to securely anchor the base member within the jaw bone.

### TECHNICAL FIELD

Present disclosure relates in general to a bio-medical device. Particularly, but not exclusively, the disclosure relates to a dental implant. Embodiments of the present disclosure relates to a dental implant assembly with a plurality of threads serving the purpose of imparting stability for dental prosthesis with an anti-rotational feature.

### BACKGROUND OF THE DISCLOSURE

India presently is in a state of major demographic shift towards elderly population. As per the 1991 census, the population of the elderly in India was 57 million as compared to 20 million in 1951. Since then, there has been a sharp increase in the number of elderly persons between 1991 and 2001. According to a Helpage India report in 2015, by 2021, the elderly population in the country will number to about 143 million and it has been projected that by the year 2050, the population number of elderly people would rise to about 324 million. India, having the highest elderly population by 2025, has thus acquired the label of “an ageing nation” with 7.7% of its population being more than 60 years. Presently, the elderly are divided into three categories: young old (between 60-70 yrs), middle-aged old (70-80 yrs) and oldest old (80 plus yrs). While the overall population of India will grow by 40% between 2006 and 2050, the population of those aged 60 yrs and above will increase by 270%. Out of this, the oldest segment, which is the most vulnerable on account of suffering from disabilities, diseases, terminal illness and dementia, is also the largest growing segment of the elderly population, at a rate of 500%.

The increase in life expectancy of Indians has a direct and amplifying effect on the prevalence of edentulism. Edentulism has an indirect effect on oral health related to quality of life. Quality of life is improved with good oral health that allows speaking, chewing, tasting, smiling, living without pain or discomfort and interacting socially without any embarrassment.

The current status of the Indian population reveals that, over half of the population has experienced tooth loss. The level of complete edentulism in general population varies from 14-16% mostly in the 60 year age group. Higher edentulism in both urban and rural elderly population is around 91.2% in elderly above the age of 65 years.

Dental health needs of our geriatric population are often overlooked. Over and above, growing population, rapid westernization and lack of resources are increasing the burden of oral diseases. More than 80% of dental surgeons are catering to the needs of 20% of the population in urban areas, while almost no dental treatment facility are available to 80% of the population living in the rural areas.

Conventionally, implants with variety of thread profiles with different tapers are reported in literature. Referring to prior art, U.S. Pat. No. 6,402,515 B1 which discloses a dental implant with variable width and helical thread profile that extends along the coronal and apical region of the implant. Another prior art document, U.S. Pat. No. 2011/0039233 A1 discloses the dental implant comprising a head with frustoconical shaped screw-like shape with series of self-tapping threads that can be used in the upper jaw-bone or the mandible bone. Further, U.S. Pat. No. 5,816,812 discloses a self-tapping tapered dental implant system having blunt leading end and major portion of implant threaded region having a thread with uniform major diameter and also having a segment with tapering minor diameter. However, collar region is polished and has a diameter slightly exceeding the uniform major diameter of the threaded region.

In view of the above, the prior art documents discloses myriad of dental implant assemblies, where some of the limitations of such implants are anchoring to a bone, stability and anti-rotation features. Some of the above disclosed prior arts illustrate implant assemblies which are defined with threaded features that, cuts into a jaw bone, but however, fail to accurately anchor the implant. Moreover, during osseointegration, the tissue growth occurs in an unplanned way around the implant leading to further complications. Moreover, due to the variety of range of patients of different age groups, bone density varies. Accordingly, conventional implants fail to determine the bone density of different patients which may lead to improper anchoring of the implant in the jaw bone leading to in-stability. Another crucial aspect is that, implanted base member in the jaw bone is not anchored or improper osseointegration leads to slippage of the base member with that of the abutment or the crown.

The present disclosure is directed to overcome one or more limitations stated above or other such limitations associated with the prior art.

### SUMMARY OF THE DISCLOSURE

One or more shortcomings of the prior art are overcome by an assembly as claimed and additional advantages are provided in the present disclosure. Additional features and advantages are realized through the techniques of the present disclosure. Other embodiments and aspects of the disclosure are described in detail herein and are considered a part of the claimed disclosure.

In one non-limiting embodiment of the disclosure, a dental implant assembly is disclosed. The dental implant assembly comprises a base member which is rotatably insertable into a jaw-bone. The base member is further defined by a collar portion, a mid-portion and an apical region. Further, the base member is defined with a plurality of threaded profiles on an outer surface. The plurality of threaded profiles comprises a first thread profile, defined on the collar portion. A second thread profile, defined on the mid-portion and a third thread profile, defined on the apical region, wherein the third thread profile is configured to cut into the jaw-bone to anchor the base member. The apical region of the base member is defined with one or more cut-outs to allow integration of at least one tissue of the jaw-bone into the base member. An abutment receivable by the base member, wherein the abutment is secured to the base member through at least one fastener.

In an embodiment, the base member is defined with an internal cavity to receive the at least one fastener and the abutment.

In an embodiment, the first thread profile is a V-grooved thread profile.

In an embodiment, the first thread profile includes a pitch ranging from 280 nm to 320 nm.

In an embodiment, the second thread profile is a buttress thread profile.

In an embodiment, the second thread profile includes a pitch ranging from 480 nm to 550 nm.

In an embodiment, the third thread profile is a macro thread profile.

In an embodiment, the third thread profile includes a pitch ranging from 0.9 mm-1.2 mm.

In an embodiment, the abutment is defined with at least one of straight profiled configuration, and an angular profiled configuration.

In an embodiment, the base member is defined with an internal cavity to receive the at least one fastener and the abutment.

In an embodiment, the internal cavity is further defined with a threaded hole to secure the at least one fastener.

In an embodiment, a tapered profile to guide the abutment into the internal cavity.

In an embodiment, a female securing portion defined in the internal cavity to secure the abutment and prevent rotation of the abutment within the base member.

In an embodiment, shape of the female securing portion of the base member corresponds to the shape of the abutment.

In an embodiment, the third thread profile of the base member facilitates in cutting into the jaw-bone, and the second thread profile forms a threaded groove within the jaw bone for anchoring the base member.

In an embodiment, the abutment is configured with a neck region at a top end of the abutment for receiving a crown.

In an embodiment, the one or more cut-outs is at least one of a straight oriented cut-out, and a helical oriented cut-out.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristics of the disclosure are set forth in the appended claims. The disclosure itself, however, as well as a preferred mode of use, further objectives and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1 illustrates side view of a base member of a dental implant assembly, defined with a plurality of threads, in accordance with one embodiment of the present disclosure.

FIG. 2 illustrates a sectional view of the base member of the dental implant assembly of FIG. 1.

FIG. 3 illustrates a side view of the base member with a cut-out, in accordance with one embodiment of the present disclosure.

FIG. 4 illustrates a side view of the base member with the cut-out defined helically, in accordance with one embodiment of the present disclosure.

FIG. 5 illustrates side view of a locking screw, in accordance with one embodiment of the present disclosure.

FIG. 6 illustrates side view of a straight profiled abutment, in accordance with one embodiment of the present disclosure.

FIG. 7 illustrates perspective view of the straight profiled abutment of FIG. 6.

FIG. 8 illustrates side view of a first angular profiled abutment, in accordance with one embodiment of the present disclosure.

FIG. 9 illustrates another side view of the first angular profiled abutment of FIG. 8.

FIG. 10 illustrates side view of a second angular profiled abutment, in accordance with one embodiment of the present disclosure.

FIG. 11 illustrates top view of the second angular profiled abutment of FIG. 10.

FIGS. 12 and 13 illustrate perspective and sectional views of a dental implant assembly with the straight profiled abutment, in accordance with one embodiment of the present disclosure.

FIGS. 14 and 15 illustrate perspective and sectional views of the dental implant assembly with the first angular profiled abutment, in accordance with one embodiment of the present disclosure.

FIGS. 16 and 17 illustrate perspective and sectional views of the dental implant assembly of FIG. 1 with the second angular profiled abutment, in accordance with one embodiment of the present disclosure.

FIG. 18 illustrates side and perspective views of a cover screw, in accordance with one embodiment of the present disclosure.

FIGS. 19 and 20 illustrate perspective and sectional views of the base member of FIG. 1 with the cover screw, in accordance with one embodiment of the present disclosure.

FIG. 21 illustrates side and perspective views of a healing abutment, in accordance with one embodiment of the present disclosure.

FIGS. 22 and 23 illustrate perspective and sectional views of the base member of FIG. 1 with the healing abutment, in accordance with one embodiment of the present disclosure.

The figures depict embodiments of the disclosure for purposes of illustration only. One skilled in the art will readily recognize from the following description that alternative embodiments of the assembly disclosed herein may be employed without departing from the principles of the disclosure described herein.

### DETAILED DESCRIPTION

While the embodiments of the disclosure are subject to various modifications and alternative forms, specific embodiment thereof has been shown by way of example in the figures and will be described below. It should be understood, however, that it is not intended to limit the disclosure to the particular forms disclosed, but on the contrary, the disclosure is to cover all modifications, equivalents, and alternative falling within the scope of the disclosure.

It is to be noted that a person skilled in the art would be motivated from the present disclosure and modify various features of the dental implant assembly, without departing from the scope of the disclosure. Therefore, such modifications are considered to be part of the disclosure. Accordingly, the drawings show only those specific details that are pertinent to understand the embodiments of the present disclosure, so as not to obscure the disclosure with details that will be readily apparent to those of ordinary skilled in the art having benefit of the description herein. However, jaw bone of a patient is not illustrated in the drawings of the disclosure for the purpose of simplicity.

The terms “comprises”, “comprising”, “includes” or any other variations thereof used in the disclosure, are intended to cover a non-exclusive inclusion, such that an assembly that comprises a list of components does not include only those components but may include other components not expressly listed or inherent to such system, or assembly, or device. In other words, one or more elements in an assembly proceeded by “comprises . . . a” does not, without more constraints, preclude the existence of other elements or additional elements in the system or device.

Embodiments of the present disclosure disclose an assembly for implanting a dental implant assembly. The dental implant assembly comprises a base member which is rotatably insertable into a jaw-bone. The base member may be defined by a collar portion, a mid-portion and an apical region. The base member in entirety may be configured with a tapered configuration right from the beginning of the mid-portion to the apical region. Further, the base member is defined with a plurality of threaded profiles on an outer surface. The plurality of threaded profiles comprises a first thread profile, defined on the collar portion. A second thread profile, defined on the mid-portion and a third thread profile, defined on the apical region. The third thread profile is configured to cut the jaw-bone during insertion to anchor the base member with primary stability. As the third thread profile cuts in to the jaw bone, the second thread profile forms a threaded hole within the drilled hole unidirectionally in order to securely anchor the base member within the jaw bone. As the base member is inserted into the jaw bone, the base member is allowed to cure for several weeks in order for osseointegration. The apical region of the base member is defined with one or more cut-outs to allow integration of at least one tissue of the jaw-bone into the base member. An abutment receivable by the base member, wherein the abutment is secured to the base member through at least one fastener.

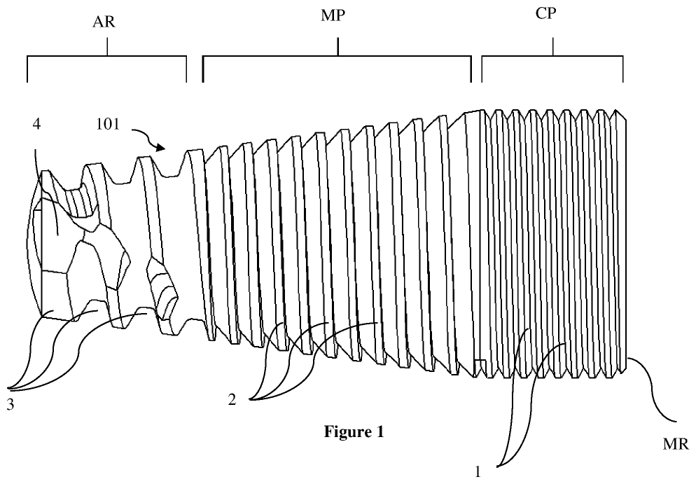

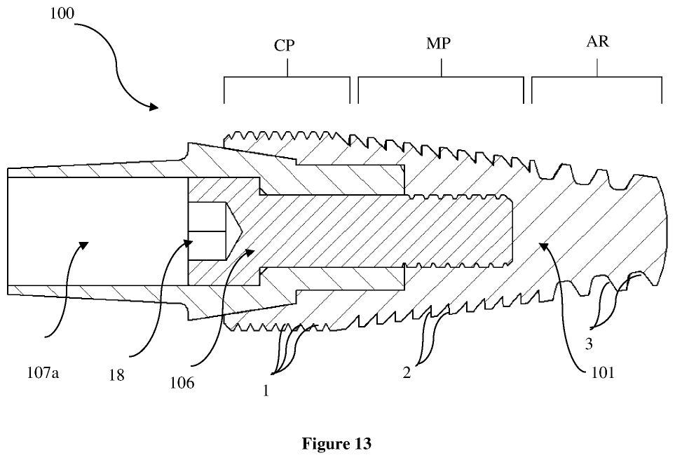

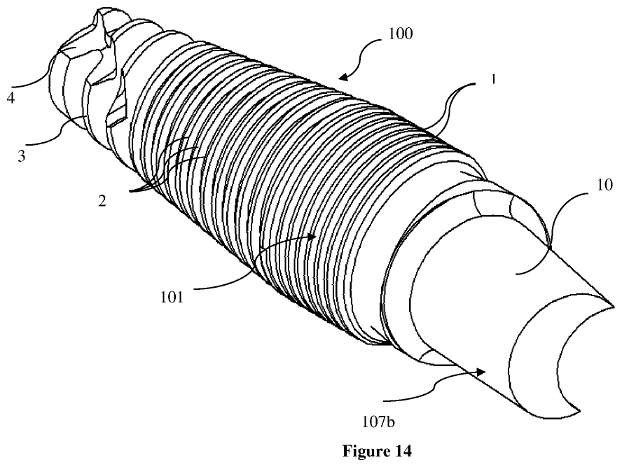

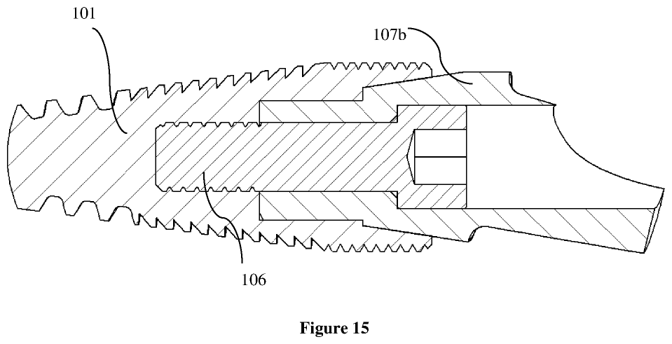

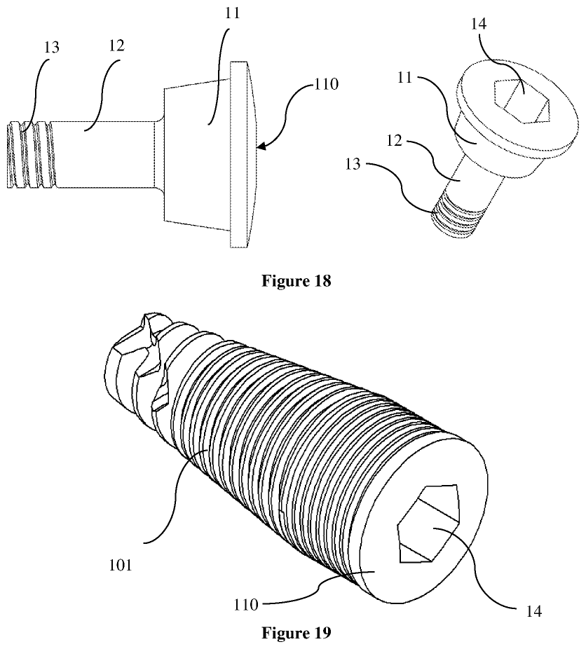

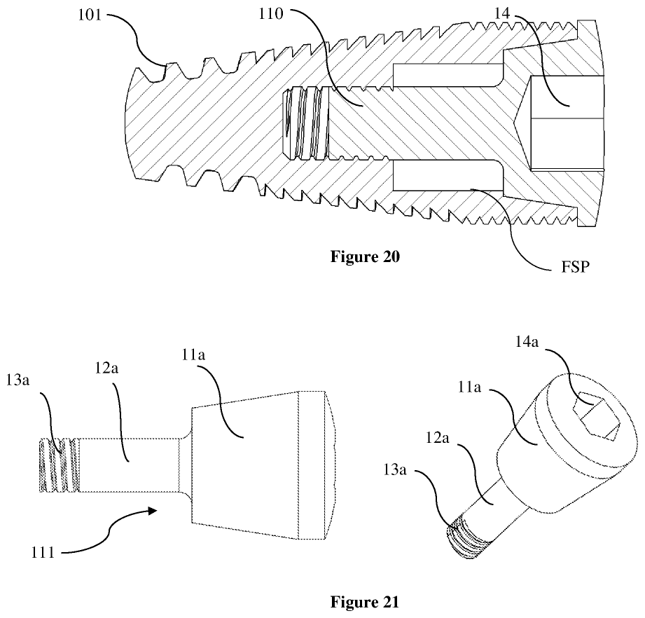

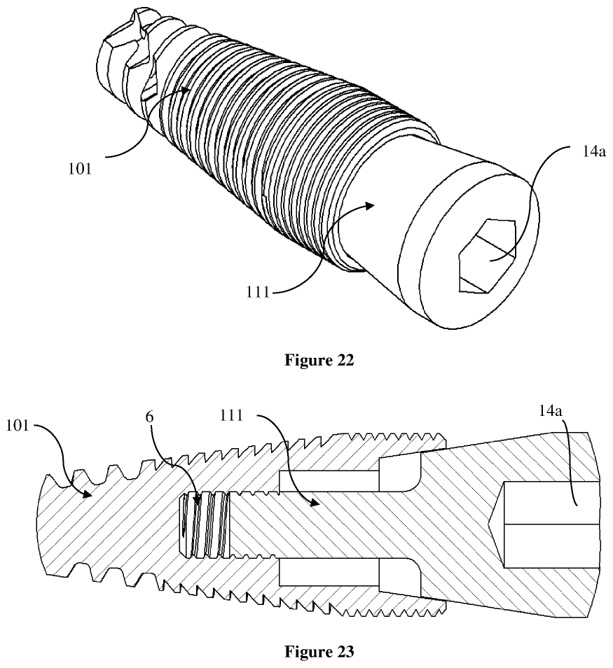

The following paragraphs describe the present disclosure with reference to FIGS. 1 to 23. In the figures, the same element or elements which have similar functions are indicated by the same reference signs.

FIG. 1 is an exemplary embodiment of the present disclosure which illustrates side view of a base member (101) of a dental implant assembly (100) [shown in FIG. 12]. The base member (101) may be defined by a collar portion (CP), a mid-portion (MP) and an apical region (AR). The base member (101) is designed such that, body of the base member (101) from the mid portion (MP) to the apical region (AR) may be conically tapered. An outer surface of the base member (101) is defined with a plurality of threads (1, 2, 3). The plurality of threads (1, 2, 3) comprises a first thread profile (1), a second thread profile (2) and a third thread profile (3).

In an embodiment, the first thread profile (1) is defined on the collar portion (CP) of the base member (101), wherein the first thread profile (1) extends from a mouth region (MR) in a direction away from the mouth region (MR) and throughout the collar portion (CP) of the base member (101). The second thread profile (2) is defined on the mid-portion (MP) of the base member (101), wherein the second thread profile (2) extends in a direction away from an end of the collar portion (CP) and throughout the mid-portion (MP) of the base member (101). Lastly, the third thread profile (3) is defined on the apical region (AR) of the base member (101), wherein the third thread profile (3). Referring to FIG. 1 and more specifically to the apical region (AR) of the base member (101), the third thread profile (3) is configured to cut into a jaw-bone (not shown in figures). As an example, when the third thread profile (3) contacts a portion of the jaw bone and as the base member (101) is torqued by a torqueing means [not shown in figure], the third thread profile (3) cuts into the jaw bone. In an embodiment, as the third thread profile (3) sinks into the jaw bone at a predetermined depth, the second thread profile (2) forms a threaded hole for securing and anchoring the base member (101) in the jaw bone. Moreover, as the base member (101) with the aid of the first and second thread profiles (2, 3) goes into the jaw bone. The third thread profile also aids in anchoring the base member (101) to provide stability to the entire dental implant assembly (100). In an embodiment, the second and third thread profiles (2, 3) in the base member (101) are configured to sink into a cancellous site of a jaw-bone of a patient.

In an embodiment, the first thread profile (1) at the collar portion (CP) of the base member (101) is configured with V-groove shaped threads and is configured to sink into a cortical shell of the jaw-bone. However, the same shall not be considered as a limitation as, any other form of thread profile may be used which imparts the same result. In an embodiment, the second thread profile (2) defined on the mid-portion (MR) of the base member (101) is configured as a buttress shaped threads (2). However, the same shall not be considered as a limitation as, any other form of thread profile may be used which imparts the same result. In an embodiment, the third thread profile (3) defined on the apical region (AR) of the base member (101) is configured with macro threads (3) along the length of the apical region (AR) of the base member (101). However, the same shall not be considered as a limitation as, any other form of thread profile may be used which imparts the same result.

In an embodiment, the apical region (AR) of the base member (101) comprises one or more cut-outs (4) defined on the third thread profile (3). The one or more cut-outs (4) may be formed over one or more threads of the third thread profile (3). The one or more cut-outs (4) so formed on the apical region (AR) facilitates healing and integration of at least one tissue of the jaw-bone during onset of osseointegration after anchoring of the base member (101). The one or more cut-outs (4) during osseointegration is configured such that, the at least one tissue present in the jaw-bone area will be in close proximity to the cut-out (4) as a triggering site for osseointegration. In an embodiment, the one or more cut-outs (4) is defined with a void region or space in order to allow growth or integration of the at least one tissue during healing or osteointegration.

In an embodiment, once the base member (101) is anchored and secured to the jaw bone and after a brief period of osseointegration, an abutment (107) may be provided in the base member whilst securing the abutment (107) through the at least one fastener (106).

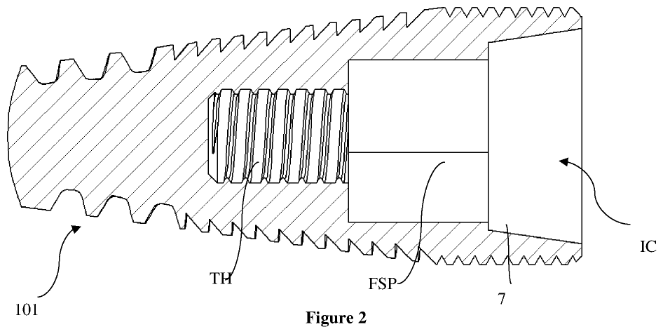

Referring now to FIG. 2 which is an exemplary embodiment of the present disclosure illustrates sectional view of the base member (101). The base member (101) is defined with an internal cavity (IC). The internal cavity (IC) of the base member (101) may be provided with threaded hole (TH) to receive the at least one fastener (106). Further, a female securing portion (FSP) is defined in the internal cavity (IC) which is adjacent to the threaded hole (TH) such that, the abutment (107) which is received in the internal cavity (IC) is prevented from rotation within the internal cavity (IC). In an embodiment, a tapered profile (7) may be configured to receive the abutment (107) and guide the abutment into the internal cavity (IC). In an embodiment, the female securing portion (FSP) is profiled in a pentagonal shape to receive the abutment (107) so as to prevent rotational movement between the base member (101) and the abutment (107). In an embodiment, the female securing portion (FSP) may be designed in a myriad of shapes ranging from hexagonal shape, torx shape, etc, based on the requirement.

In an embodiment, the tapered profile (7) in the internal cavity (IC) of the base member (101) is configured with a polished surface in order to facilitate close tolerance fit with surface of the abutment (107).

In an embodiment, the base member (101) is configured to be implanted at a molar site (however the same is not limited to any site with variation of length and diameter) of the patient. The base member (101) has an overall length ranging from 8 mm to 14 mm Further, the diameter of the base member (101) at the collar portion (CP) ranges between 3 mm to about 6 mm

In an embodiment, the base member (101) at its tapered portion (conical shape) is configured with a taper angle ranging from 15° to 16°, wherein the end of the tapered portion is provided with a dome.

In an embodiment, wherein the first thread profile (1) has a pitch ranging between 280 nm to 320 nm, wherein the second thread profile (2) has a pitch ranging between 480 nm to 550 nm, wherein the third thread profile (3) has a pitch ranging between 0.9 mm-1.2 mm

In an embodiment, the V-grooved threads (1) defined on the collar portion (CP) of the base member (101) are configured with the pitch length in the range of about 0.25 mm to about 0.45 mm and the height in the range of about 0.1 mm to about 0.3 mm with an alignment angle of about 60°.

In an embodiment, the one or more cut-outs (4) defined at the apical region (AR) of the base member (101) may be designed as at least one of a straight oriented cut-out, and a helical oriented cut-out. The straight oriented cut-out (4) extends from a tip portion of the apical region (AR) along a predetermined length along the body portion of the base member (101).

In an embodiment, the plurality of buttress threads (2) defined on the mid-portion (MP) of the base member (101) are configured with a pitch length in the range of about 0.3 mm to about 0.6 mm and a height in the range of about 0.2 mm to about 0.4 mm with an alignment angle of about 45°.

In an embodiment, the plurality of macro threads (3) or the third thread profile (3) [also termed as plurality of macro threads (3)] defined on the apical region (AR) of the base member (101) may cover ⅓^{rd} to ½^{th} of the length from the apical region (AR). The plurality of the macro threads (3) is configured with a pitch length in the range of about 0.9 to 1.2 mm and a height in the range of 0.4-0.6 mm with a thread angle range of 40°-50°, wherein the thread angles and thread heights are maintained such a way that there would be an inter-thread gap.

In an embodiment, the base member (101) defined with the one or more cut-outs (4) is a right handed helical cut-out defined on the apical region (AR) of the base member (101). The depth of the one or more cut-outs (4) at the bottom end ranges between 0.4-0.6 mm from the outer surface which gradually decreases during climbing up and diminishes at the vertical length of around 3 mm from the apical region (AR) of the base member (101).

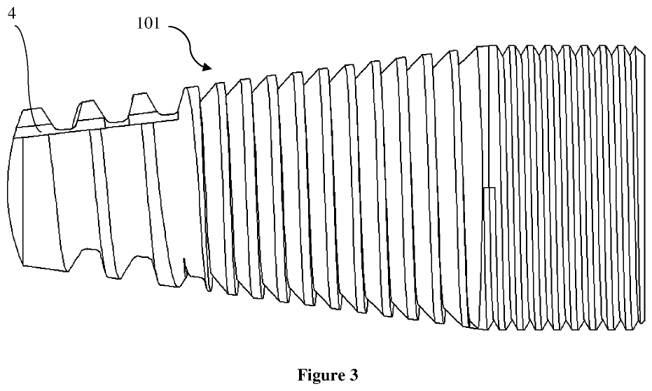

Referring to FIG. 3 which is an exemplary embodiment of the present disclosure illustrates the side view of a base member (101) with at least one or more cut-outs (4) in a straight cut-out configuration. As the base member (101) is anchored and secured into the jaw bone, the base member (101) is allowed to heal for about 2 to 3 week's time. During this time, the at least one tissue [not shown in figures] of the jaw bone starts to integrate with base member (101) more specifically the at least one tissue grows and integrates in the one or more cut-outs (4).

In an embodiment as illustrated in FIG. 4, the base member (101) defined with the first, second and third thread profiles (1, 2, 3) has continuous thread profiles with the thread angle ranging between 75°-95° (i.e. only the third thread profile). The thread angles and thread heights are formed in such a way that, there would not be any inter-thread gap on the body of the base member (101). In an embodiment, the base member (101) comprises a right handed helical one or more cut-outs (4) identical to the dimension of the base member (101) as shown in FIG. 1. The depth of the one or more cut-outs (4) formed on the apical region (AR) of the base member (104) ranges between 0.4-0.6 mm from the outer surface, which gradually decreases during climbing up the body of the base member (101) and diminishes at the vertical length of around 3 mm from the apical region (AR).

Referring to FIG. 4 which is an exemplary embodiment of the present disclosure illustrates side view of the base member (101) which depicts one or more cut-outs (4) having an angularly shaped cut-out. In an embodiment, the one or more cut-outs (4) includes a void region or space to allow growth of the at least one tissue during healing period and osseointegration.

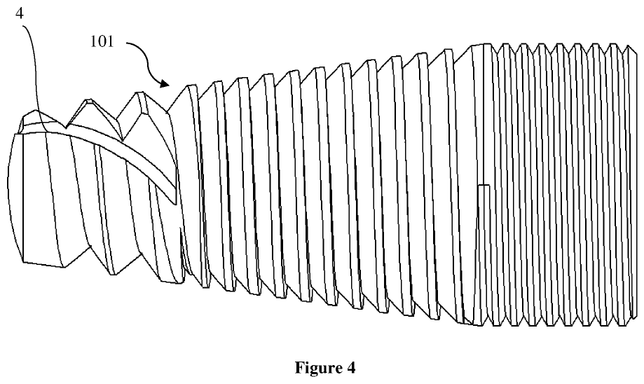

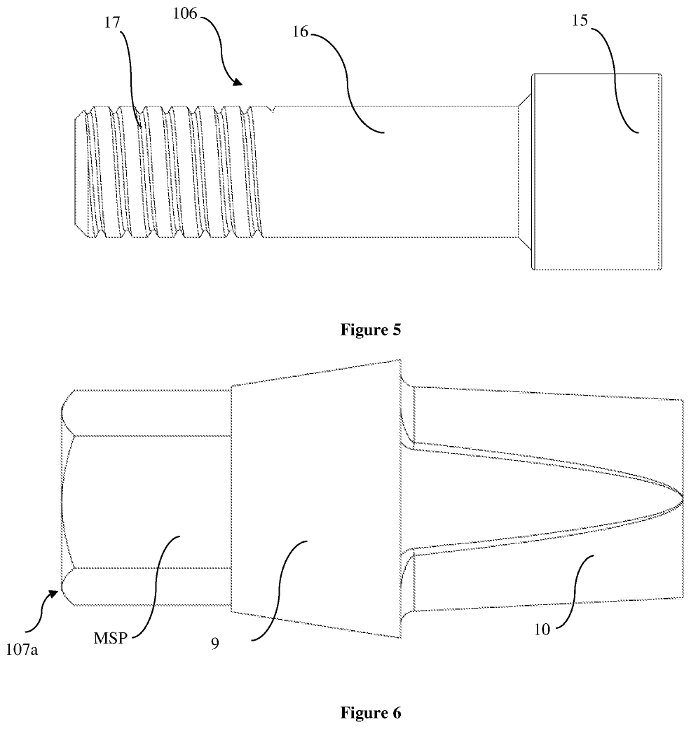

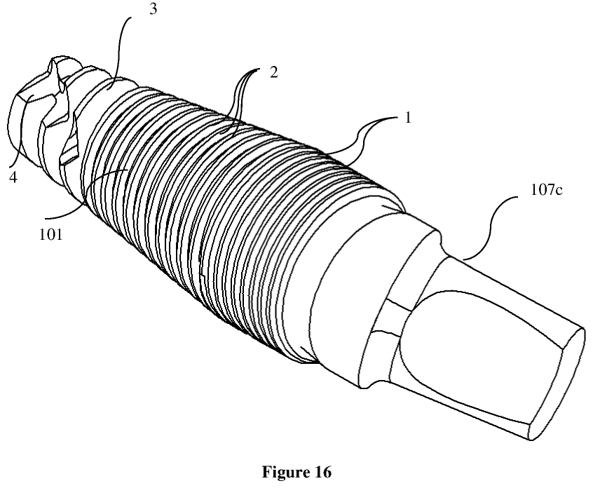

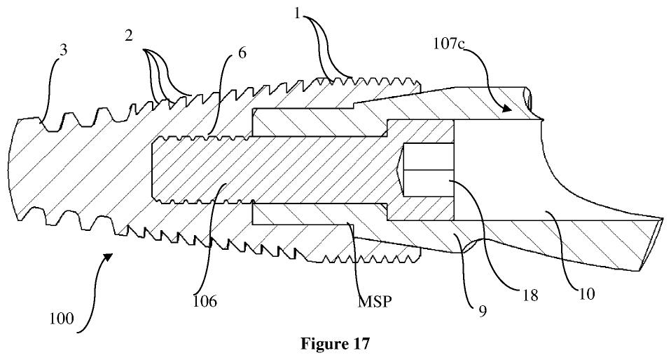

Referring to FIG. 5 which is an exemplary embodiment of the present disclosure illustrates side view of at least one fastener (106) of the dental implant assembly (100). The at least one fastener (106) is configured to secure the abutment (107) into the base member (101). In an embodiment, the at least one fastener (106) comprises a head portion (15) provided with an Allen key groove (18) [shown in FIG. 17] for allowing a torque tool to secure the abutment (107) within the internal cavity (IC) of the base member (101). In an embodiment, end of the at least one fastener (106) is configured with the threaded part (17) that matches with the threaded hole (TH) provided within the internal cavity (IC) of the base member (101). Further, the at least one fastener (106) comprises a shank portion (16) which is threadedly engaged with the threaded hole (TH) defined in the internal cavity (IC) of the base member (101).

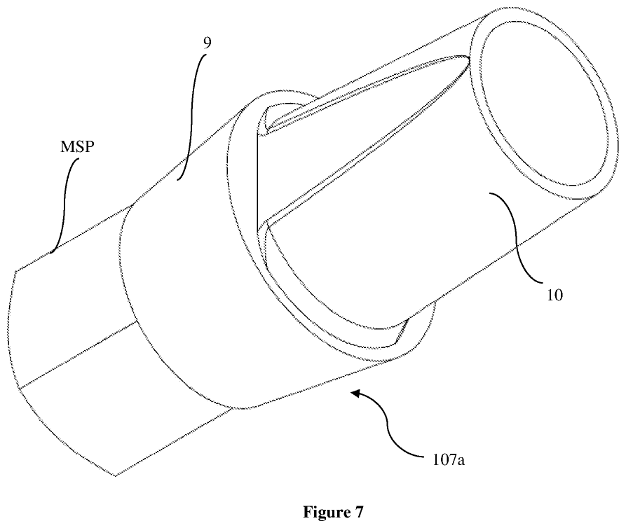

Referring to FIGS. 6 and 7 which are an exemplary embodiment of the present disclosure illustrate side and perspective views of a straight profiled abutment (107a) which comprises a male securing portion (MSP) provided at end of the straight profiled abutment (107a), wherein the male securing portion (MSP) mates with the female securing portion (FSP) provided in the internal cavity (IC) of the base member (101). In an embodiment, a central portion of the straight profiled abutment (107a) comprises the tapered profile which is configured to match the tapered profile (4) defined in the internal cavity (IC) of the base member (101). In an embodiment, a neck portion (10) is provided at top end of the straight profiled abutment (107a) for placing a tooth crown [not shown in figures].

In an embodiment, the straight profiled abutment (107a) secures within the base member (101) with the help of the at least one fastener (106), wherein the male securing portion (MSP) provided on the abutment (107) and the female securing portion (FSP) provided in the internal cavity (IC) of the base member (101) restricts rotational movement of the dental implant assembly (100).

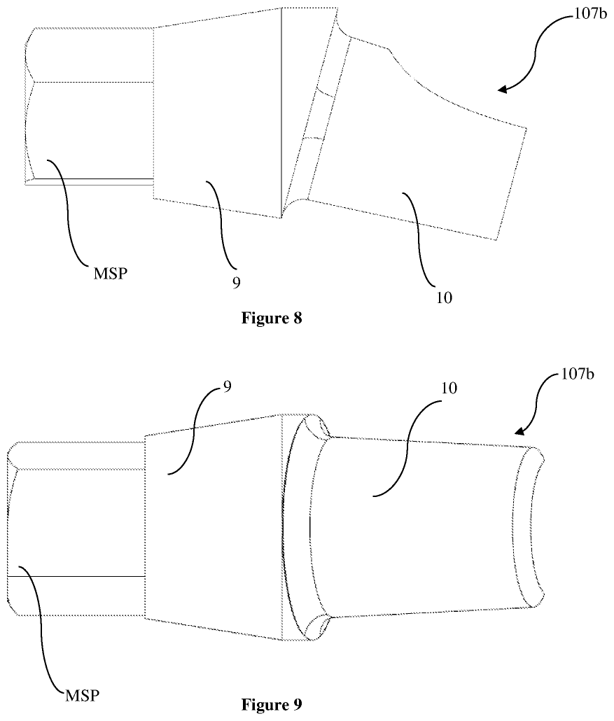

Referring to FIGS. 8 and 9 which are an exemplary embodiment of the present disclosure illustrates side views of the first angular profiled abutments (107b) of the dental implant assembly (100). The first angular profiled abutment (107b) is defined with the male securing portion (MSP) that mates with the female securing portion (FSP) defined in the internal cavity (IC) of the base member (101). In an embodiment, the first angular profiled abutment (107b) is angled at an angle ranging from about 12° to about 17° in order to cater for patients having non-ideal jaw-bone condition. In an embodiment, some patients may have their jaw-bone tilted towards a particular angle. In such scenarios, the base member (101) will be sunk into the patient's jaw-bone in a particular angle. However, due to the first angular profiled abutment (107b), restoration can be carried out vertically in line with neighboring teeth by placement of the first angular profiled abutment (107b).

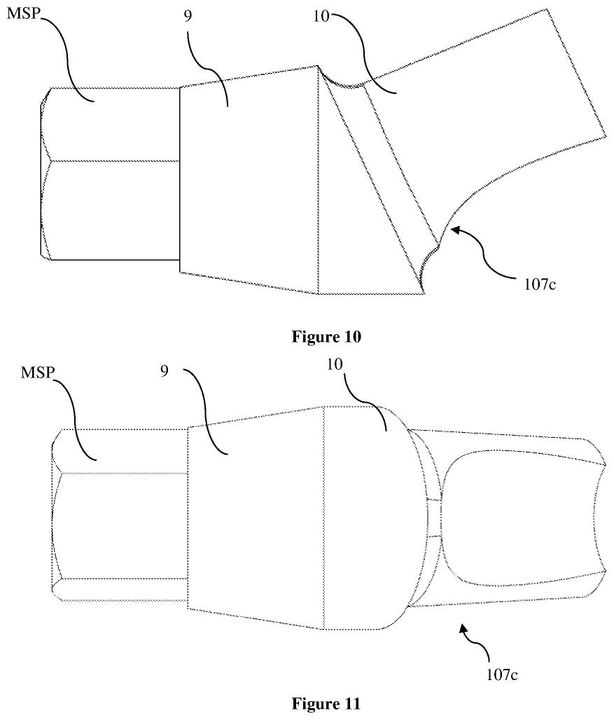

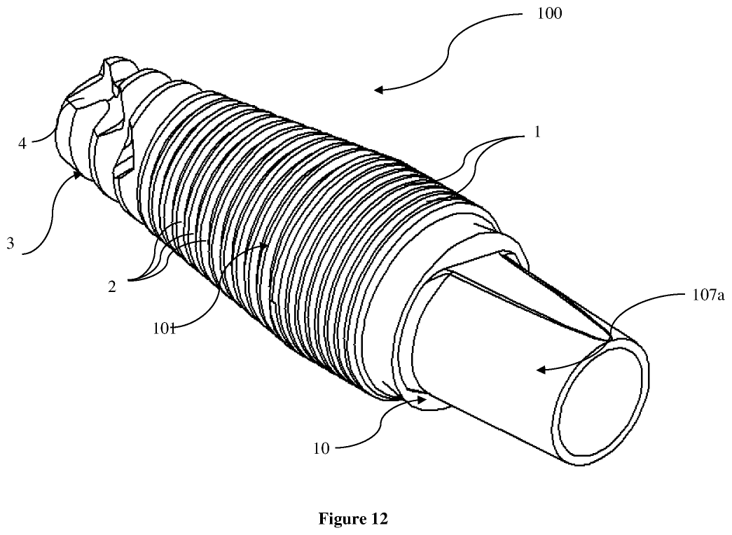

Referring to FIGS. 10 and 11 which are an exemplary embodiment of the present disclosure illustrates side views of the second angular profiled abutment (107c) of the dental implant assembly (100). In an embodiment, the second angular profiled abutment (107c) is configured to incorporate an angle ranging from about 22° to about 27° in order to cater for the patients having non-ideal jaw-bone condition. In an embodiment, few patients may have their jaw-bone tilted towards a particular angle. In such scenarios, the base member (101) will be sunk into the patient's jaw-bone in a particular angle. However, due to the second angular profiled abutment (107c), restoration can be carried out vertically in line with neighboring teeth by placement of the second angular profiled abutment (107c).

Referring to FIGS. 12, 13, 14, 15, 16 and 17 which are an exemplary embodiment of the present disclosure illustrates perspective and sectional views of the dental implant assembly (100) with the straight profiled abutment (107a), the first angular profiled abutment (107b) and the second angular profiled abutment (107c). In one non-limiting embodiment of the present disclosure a method of implanting the dental implant assembly (100) into the jaw-bone is disclosed. The method includes the steps of implanting the base member (101) into jaw-bone of the patient and allowing the base member (101) to heal for a period of about 2 months to about 3 months. In an embodiment, during the healing process, the method includes covering the base member (101) with a cover screw (110) or with a healing abutment (111) to prevent tissue growth within internal cavity (IC) of the base member (101). During this healing period, the at least one tissue of the jaw-bone of the patient starts to osseointegrate with the base member (101) which secures the jaw-bone of the patient with the base member (101). In an embodiment, the method further includes removing the cover screw (110) and placing the healing abutment (111) onto the base member screw (101) to facilitate forming of gingival contour and emergence profile for the abutment/prosthesis in the gingiva for a couple of weeks. In an embodiment, once the healing period is completed, the method includes removing the healing abutment (111) and placing any one of the abutments (107a, 107b, 107c) based on the ideal or non-ideal jaw-bone condition of the patient, to couple with the base member (101). In an embodiment, the method includes inserting the at least one fastener (106) into the internal cavity (IC) of the base member (101) to secure the abutment (107a, 107b, 107c) and the base member (101). Finally, the method includes placing a tooth crown [not shown in figures] in the neck portion (10) of the abutment (107).

Referring to FIGS. 18, 19 and 20 which is an exemplary embodiment of the present disclosure illustrates side view of the cover screw (110), perspective view and section views of a cover screw (110) mounted to the base member (101) of the dental implant assembly (100). In an embodiment, the cover screw (110) comprises of a head portion (11) configured with a hex groove (14). The cover screw (110) further comprises a shank portion (12) which is connected to the head portion (11) which is configured to travel up to nearly half of the internal cavity (IC) of the base member (101). The end of the shank portion (12) is configured with a threaded part (13) to match the threaded cavity (6) in internal cavity (IC) of the base member (101). In an embodiment, the cover screw (110) covers the opening of the base member (101) as a cap to prevent any tissue growth within the internal region of the base member (101) during healing period.

Referring to FIGS. 21, 22 and 23 which is an exemplary embodiment of the present disclosure illustrates side view of a healing abutment (111), along with sectional and and perspective views of the healing abutment (111) mounted in the base member (101) of the dental implant assembly (100). In an embodiment, the healing abutment (111) comprises a head portion (11a) configured with the hex groove (14a). The healing abutment (111) further comprises a shank portion (12a) which is connected to the head portion (11a), wherein the shank portion (12a) is configured to travel up to nearly half of the internal threaded cavity (6) of the base member (101). In an embodiment, full thread engagement of the healing abutment (111) is not encouraged to avoid difficulty during withdrawal after healing period. Also, the end portion of the healing abutment (111) may be configured with threaded part (13a) to match the threaded cavity (6) on the void chamber (20) of the base member (101). In an embodiment, the healing abutment (111) resembles closely to the cover screw (110), however, the healing abutment (111) has additional length at the tapered region that matches with the tapered tunnel (4) of the base member (101). The additional length emerges through the gingiva to maintain the contour for placing the final abutment. This additional length of the healing abutment (111) is configured by taking into consideration an average gingiva thickness to be around 3 mm to 4 mm.

In an embodiment, the plurality of thread profiles (1, 2, 3) are machined using precision tools such as computer numerical control (CNC) machining and electrical discharge machining (EDM). The machining process used involved close tolerances and precise engineering in manufacturing the plurality of thread profiles (1, 2, 3). Once the manufacturing of the base member (101), the abutment (107) and the at least one fastener (106) is completed, sandblasting procedure was followed by two-stage acid-etching to achieve the surface roughness which is clinically accepted for best osseointegration.

Equivalents:

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system (108) having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system (108) having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

REFERRAL NUMERALS

| REFERRAL | |
|---|---|
| NUMERALS | DESCRIPTION |
| IC | Internal cavity |
| CP | Collar portion |
| MP | Mid-portion |
| AR | Apical region |
| TH | Threaded hole |
| FSP | Female Securing Portion |
| 100 | Dental implant assembly |
| 101 | Base member |
| 106 | Fastener |
| 107 | Abutment |
| 107a | Straight profiled abutment |
| 107b | First angular profiled abutment |
| 107c | Second angular profiled abutment |
| 110 | Cover screw |
| 111 | Healing abutment |
| 1, 2, 3 | Plurality of threads |
| 1 | First thread profileN-grooved threads |
| 2 | Second thread profile/ Buttress threads |
| 3 | Third thread profile/macro threads |
| 4 | One or more cut-outs |
| 6 | threaded cavity |
| 7 | Female tapered profile |
| MSP | male securing portion |
| 9 | Male tapered profile |
| 10 | Neck |
| 11 | Head portion of cover screw |
| 12 | Shank portion of cover screw |
| 13 | Threaded part of cover screw |
| 14 | Allen key groove of cover screw |
| 11a | Head portion of healing abutment |
| 12a | Shank portion of healing abutment |
| 13a | Threaded part of healing abutment |
| 14a | Allen key groove of healing abutment |
| 15 | head portion of locking screw |
| 16 | shank portion of locking screw |
| 17 | Threaded part of locking screw |
| 18 | Allen key groove of locking screw |

1. A dental implant assembly (100), the assembly (100) comprising:
a base member (101) rotatably insertable into a jaw-bone, wherein the base member (101) is defined by a collar portion (CP), mid-portion (MP), and an apical region (AR), and wherein the base member (101) is defined with a plurality of threaded profiles (1, 2, 3) comprising:
a first thread profile (1), defined on the collar portion (CP);
a second thread profile (2), defined on the mid-portion (MP);
a third thread profile (3), defined on the apical region (AR), wherein the third thread profile (3) is configured to cut into the jaw-bone to anchor the base member (101);
wherein the apical region (AR) of the base member (101) is defined with one or more cut-outs (4) to allow integration of at least one tissue of the jaw-bone into the base member (101); and
an abutment (107) receivable by the base member (101), wherein the abutment (107) is secured to the base member (101) through at least one fastener (106).

2. The dental implant assembly (100) as claimed in claim 1, wherein the base member (101) is defined with an internal cavity (20) to receive the at least one fastener (106) and the abutment (107).

3. The dental implant assembly (100) as claimed in claim 1, wherein the first thread profile (1) is a V-grooved thread profile.

4. The dental implant assembly (100) as claimed in claim 1, wherein first thread profile (1) includes a pitch ranging from 280 nm to 320 nm.

5. The dental implant assembly (100) as claimed in claim 1, wherein the second thread profile (2) is a buttress thread profile.

6. The dental implant assembly (100) as claimed in claim 1, wherein the second thread profile (2) includes a pitch ranging from 480 nm to 550 nm.

7. The dental implant assembly (100) as claimed in claim 1, wherein the third thread profile (3) is a macro thread profile.

8. The dental implant assembly (100) as claimed in claim 1, wherein the third thread profile (3) includes a pitch ranging from 0.9 mm-1.2 mm.

9. The dental implant assembly (100) as claimed in claim 1, wherein the abutment (107) is defined with at least one of straight profiled configuration, and an angular profiled configuration.

10. The dental implant assembly (100) as claimed in claim 1, wherein the base member (101) is defined with an internal cavity (IC) to receive the at least one fastener (106) and the abutment (107).

11. The dental implant assembly (100) as claimed in claim 10, wherein the internal cavity (IC) is further defined with a threaded hole (TH) to secure the at least one fastener (106).

12. The dental implant assembly (100) as claimed in claim 10, comprises a tapered profile ( ) to guide the abutment (107) into the internal cavity (IC).

13. The dental implant assembly (100) as claimed in claim 10, comprises a Female securing portion (FSP) defined in the internal cavity (IC) to secure the abutment (107) and prevent rotation of the abutment (107) within the base member.

14. The dental implant assembly (100) as claimed in claim 1, wherein shape of the female securing portion (FSP) corresponds to the shape the abutment (107).

15. The dental implant assembly (100) as claimed in claim 1, wherein the third thread profile (3) of the base member (101) facilitates in cutting into the jaw-bone, and the second thread profile (2) forms a threaded groove within the jaw bone for anchoring the base member (101).

16. The dental implant assembly (100) as claimed in claim 1, wherein the abutment (107a, 10b, 107c) is configured with a neck region (10) at a top end of the abutment (107a, 10b, 107c) for receiving a tooth crown.

17. The dental implant assembly (100) as claimed in claim 1, wherein the one or more cut-outs (4) is at least one of a straight oriented cut-out, and a helical oriented cut-out (4).
